(19) United States
(12) Patent Application Publication
(10) Pub. No.: US 2009/0272279 A1
(43) Pub. Date: Nov. 5, 2009

(54) Storage and/or heating system/apparatus for items and food

(76) Inventor: Timothy Adam Kieck, Waukesha, WI (US)

Correspondence Address: TIMOTHY A. KIECK, PO Box 2077, WAUKESHA, WI, 53187-2077, US

(21) Appl. No.: 12/497,836

(22) Filed: Jul. 6, 2009

Related U.S. Application Data
(63) Continuation of application No. 10/389,603, filed on Mar. 17, 2003, now abandoned.
(60) Provisional application No. 60/429,020, filed on Nov. 26, 2002.

(51) Int. Cl. B65D 81/20; A47J 36/00; A47J 43/00

(52) U.S. Cl. 99/468; 99/472

(57) ABSTRACT

The invention is a universal or designated storage apparatus, facility, or appliance with increased versatility and sophisticated storage fundamentals and capabilities for the storage of a wide variety of items. It provides support for complimenting and assisting with the use and coordination of the apparatus and the items kept within, while utilizing simple and basic storage means and methods in order to remain efficient, effective, and convenient. Items can then be accessed more frequently without hassle or burden. It may also include vacuum pumping means to remove or expel air from within a sealed storage area in order to form a vacuum or partial vacuum, negative atmospheric pressure, or suction creating means. This provides an air-free environment for items to be kept within, which retains freshness and retards the formation of mold or other contaminants. It may also provide means to allow items kept within to be organized and coordinated in a customizable fashion. It may also provide certain means to allow a user to prepare items for use or consumption. It can be equip with many features which allows it to be used with ease. This apparatus will aid in organization and sanitation.

### CROSS-REFERENCE TO RELATED APPLICATIONS

This invention is in continuation of and claims benefits of two non-provisional applications, application Ser. No. 10/389,603 filed on Mar. 17, 2003 titled “Appliance for the universal storage of baked goods with a built in vacuum pump”, and application Ser. No. 11/501,251 filed on Aug. 9, 2006 titled “Universal preparation and organization station/facility and airtight apparatus/appliance for the storage of baked goods and/or foodstuffs with a built in vacuum pump”. This invention also claims benefits from two provisional applications, application No. 60/429,020 filed on Nov. 26, 2002 titled “Vacuum sealed breadbox”, and 60/501,657 filed on Sep. 11, 2003 titled “Airtight Apparatus for the universal storage of baked goods with a built in vacuum pump”. This invention also claims benefits from disclosure documents, #509451, filed on Apr. 8, 2002 and #528,599, filed on Mar. 21, 2003 to provide evidence of conception describing the invention herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

There have been many apparatuses over the years that have been used to store many different types of items, all which have their own unique characteristics and advantages over one another. These apparatuses have led the way until present as far as storage is concerned. There have also been inventions that use vacuum compartments to provide means to store and keep things, which can be dated back to the 1800's. Though there have been many methods and advances in storage since that time, there are still many ways of applying these concepts in a manner which are useful and practical.

Many of the present day means do not provide universal storage for a wide variety of different items. There still remains many problems, issues, or concerns when storing a variety of items with different characteristics. Many items do not store well or which are not stored at all. There always remains a storage bias for any given item because of characteristics or properties that each item possesses. For example, storing moist items in a container typically used to store dry items is not a suitable match. There are many sizes, shapes, and types of apparatuses used for many purposes which still do not take certain characteristics or properties into consideration. When storing things of different nature, there are specific needs or details that need attention in order for the apparatus to be a suitable storage solution. This holds true for each and every type and item being stored, especially when many items of variety need to be stored simultaneously.

There always arises an issue of lacking in versatility and when many items of different variety or quantity need to be stored, especially being of similar nature, it becomes a hassle or burden to apply different storage methods for each item separately instead of storing them in the same apparatus. For example, storing bread, potato chips, and muffins would all be done differently because of shape, amount of mess (such as oil residue or fruit fillings), and quantity. There needs to be more versatility and options available for storage. Many present day storage methods or apparatuses do not provide means to overcome these problems and they lack in the basics of more sophisticated storage fundamentals. Items are then stored in an ineffective and inefficient fashion.

In reference to patents U.S. Pat. No. 303,014 (Hoyt), U.S. Pat. No. 4,278,114 (Ruberg), and U.S. Pat. No. 5,449,079 (Yang); These inventions reference apparatuses that use manual pumping means which are used to create vacuums within sealed containers. There are certain problems and issues that are still not solved with the use of such devices. There still remains problems related to storage of larger types and quantities of items, whereas with the use of these devices with larger containers or compartments can not be achieved due to the manual exertion needed to create a vacuum within them which is time consuming and redundant. Use of manual dexterity and strength is also required which some people may not have. Many of the devices are also cylindrical in shape, which would not be effective for many items such as: bread (which is usually or in many instances shaped like a square), square crackers, or hotdog buns. It would also not be effective for other items or foods such as: iced donuts or frosted cupcakes which would not stack well in such a shaped container, as the icing and frosting would create a mess and would not be neat and tidy. These problems are non-desirable. It would be much more appropriate to store such items in an apparatus which takes these certain characteristics into consideration. These devices are also not able to store collections of items in the same storage area due to lack of organizational means. These units also use special pumps or pumping methods or they use special valves for creating a vacuum which in certain cases is not necessary, practical, or desirable.

In reference to patents U.S. Pat. No. 5,946,919 (McKinney et al.) and U.S. Pat. No. 7,040,356 (Tarlow); These inventions are food storage appliances which make specific and detailed environmental changes to their enclosures. They also function as vacuum sealed compartments for certain food items. Aside from vacuum they also maintain temperature, humidity, and also introduce ozone, UV radiation, and activated charcoal to the storage areas to kill unwanted contaminants present within. The use of these elements is unnecessary in many instances and would require electricity or larger amounts of, to operate. The use of simpler or basic storage means would be more appropriate and practical for a wide variety of foods.

Furthermore, ozone is a toxic gas and entering it into a place where food is going to be kept could be a health hazard. It also has an impact on the chemical composition of water, which many foods contain much of.

Also, ozone and UV radiation is intended to kill bacteria, mold, fungus, and other pathogens. These organisms are only present due to error and carelessness. These organisms play a vital role in nature. They assist to clean up wasted and undesirable foods and other waste and they should be embraced not harmed. It is not necessary to kill living organisms in order to remain sanitary. The issue is essentially poor hygiene and management of the storage area and foods kept within. UV radiation could also impact the foods it comes in contact with. Also, the storage of batteries in a refrigerator could be hazardous as moisture and other variables could cause batteries to rupture or leak. Also, requiring batteries for storage of frequently accessed food items may tend to be expensive, wasteful, and a hazard to the environment.

The complexities of these inventions render them from providing streamlined storage for many items. Also, these appliances are used to store food and would not be suitable for storing many other items. For example, you wouldn't store stamps or makeup in a humid or refrigerated environment. These apparatuses do not provide organizational means and are not coordinated in such a manner which enables effective storage of a vast array of items. They also may tend to lack in portability which could be an issue in many cases.

In reference to patent U.S. Pat. No. 5,570,628 (Kiener et al.); The apparatus described in this patent is a food conservation system which is designed to hold a variety of non-related items such as: salad, sausages, vegetables, bread or other baked goods. The apparatus is also equipped with a vacuum pump which removes air from an enclosed space within a hood.

There are many limitations this invention has by its structure and its overall lack of ability to be versatile. One large problem is the built-in pump which acts on two separate areas, one of which is not used for storage, whereas the pump is used to remove air from an unnecessary compartment. Another issue is the use of a foil to keep foods separate from the hood, which can be unnecessary in certain instances.

The storage of messy foods such as meats could leave grease or residue and other such foods remnants or moisture. Storing non-related food items could then come in contact with such remnants or moisture. This could be a hassle or burden to clean and stay sanitary. Since the base contains specific vacuum needs it could be complicated and harder to clean and potentially could even ruin the authenticity of the pump or the entire system. The remnants could cause blockage of the air passage from the base to the pump since the air passage resides in the base. The system is not coordinated in such a manner to provide efficient or effective storage of dissimilar items in the same apparatus.

The method of collection could also be dirty and unsanitary, particularly when perishable wastes are collected in the waste dish. It could sit for awhile under humid or moist conditions, especially when housing certain food items that have higher moisture content such as lettuce or other vegetables. This has potential to create an unsanitary issue. Such vegetables would need to be washed before consumption and would need to be dried before putting it into the apparatus in order to keep excess moisture out which could actually promote the growth of bacteria or other contaminants. Also any moisture or liquid sitting in the collection dish could potentially cause undesirable conditions of humidity inside the enclosure. Forgetting to clean out the waste collection dish could be a hassle or burden.

Such arrangements and the way the system is devised in order to contain air is not suitable for frequent access and requires the use of a foil in connection with the seal to be used in order to contain the vacuum.

In reference to patent U.S. Pat. No. 5,964,255 (Schmidt); This apparatus is a portable food preservation system which is powered by batteries to be used in various places where portable means is necessary.

One main difference with this invention is its limited power supply, whereas it operates on the use of batteries to engage the vacuum pump. This has many limitations and would not provide the strength which is needed to power a pump which needs to remove air from larger enclosures. The use of batteries would fail to provide enough power to a pump for such means.

Another issue is the time it would take for a battery powered vacuum pump to fully expel air from within the enclosure in an efficient amount of time. A pump which is pumping longer could be non-desirable and has potential to be noisy. This problem could be substantial, especially when dealing with larger pumps carrying out the task of evacuating air from a large enclosure.

Batteries have a potential to corrode which are housed inside the same apparatus which contains food. It could cause a serious health concern or a non-desirable circumstance all together. This would especially be true under moist, humid, or other conditions, such as overnight camping or summer heat waves. The batteries could also overheat and burst or leak, especially being dormant for long periods in a sun baked trailer or RV. The use of batteries in the kitchen also is not necessary as most kitchens would have adequate power sources.

Furthermore, the storage area of the unit is limited and would not allow storage of large quantities of food items. It also requires the use of a pump which does not provide basic storage means. A pump might not be necessary at all in certain circumstances. The apparatus also has additional limitations as far as size is concerned.

In reference to patent U.S. Pat. No. 6,148,875 (Breen); This patent uses a vacuum enclosure for the purpose of storing fruit, vegetables, or cold cuts and implementing the enclosure inside a refrigerator or freezer, and also for the use of food transportation. This system does not provide an economical way to store different types of items in the same unit. The storage of different types of food together can cause cross contamination of different types of mold or bacteria, and this can lead to sanitation issues. The storage of different types of food together can also affect their flavor, aroma, and other such qualities. The only way to avoid this issue would be to use packaging or separate bags for different foods types which would defeat the purpose of having a fully exposed storage area. Also, storing items in a refrigerator or freezer can degrade their original authenticity such as: texture, taste, and aroma. Again, some types of items aren't meant to be refrigerated at all. For example, you wouldn't put cookies inside the refrigerator for later consumption.

Even if one would like to use such a system, they would have to install it themselves into their existing refrigerators or even go out and purchase a new refrigerator, with the system built in. This can be expensive, time consuming, and involve too much technicality.

In reference to patent FR-2767912 (Camus et al.); This apparatus contains two vacuum sealed enclosures, one of which stores bread which is also equip with heating means and another for storage of wine and cheeses in a refrigerated environment. It does not provide suitable arrangements to be functional as a universal storage apparatus for a vast array of items.

Creating heat within an enclosure will have serious affects on the time it takes for the air inside or the apparatus itself to cool down, even when a vacuum is applied to expel any heated air within. The compartment when heated in such a manner to produce enough results in order to warm substantial portions of bread would then need substantial time to cool. This heat could also cause problems with humidity and excess drying of foods kept within, especially when larger amounts of foods are being kept. It is also a possibility that one could accidentally engage the heat pump when many foods kept within are not intended to be heated. One would have to take out any portions of food which are not intended to be heated before the heating pump is turned on. This food could be of a substantial quantity, variety, or quality which would need to be taken out each and every time the heat pump is turned on. This could cause disorganization and undesirable problems or complications.

Also any crumbs or particles of food left inside of the compartment could dry out or become messy, especially where heat is applied to foods which have a tendency to become dry enough to crumble, flake, or have crumbs fall off. This could be messy and have a tendency to blow around when the door is opened or when the vacuum seal is released. These remnants left from previous use of certain foods could have potential to, or eventually burn. Any sticky residues left from donuts, muffins, or pastries such as: fruit filling, icing or frosting, or sugar could stick to the walls or floor and when heated could cause a sticky mess which could become hardened or caked to the surfaces within a compartment. Even after the first heating, and especially over time, this mess could even burn. This could be overwhelmingly difficult to clean, and would require excessive maintenance.

This combination of hot and cold may only be needed or necessary at certain times and having such a unit to store wine, cheese, and bread, for example when only bread needs to be stored is not practical. Use of the refrigerated compartment in combination with the heated compartment when one or the other is not needed is impractical. The cooling means is not necessary to keep certain goods fresh. Foods needing refrigeration could very well just be refrigerated in a conventional refrigerator instead of requiring an apparatus employing both and vice versa. Again, there are many items not intended to be stored in an area where temperature is altered.

Overall, none of the fore mentioned inventions provide an economical way to store a wide variety of items and types in the same unit. The storage of different types of items together or in a refrigerator can affect qualities such as: flavor, aroma, or taste, and it could degrade or have an impact on the item's overall authenticity. The storage of different types of items together can cause cross contamination of different types of mold, bacteria, or other pathogens and this can lead to sanitation issues. There are certain types of environments which are only appropriate under certain conditions or circumstances and are only practical for certain items.

### BRIEF SUMMARY OF THE INVENTION

The invention is a universal storage apparatus, facility, or appliance with increased versatility and sophisticated storage fundamentals and capabilities for the storage of a wider variety of items. It provides support for complimenting and assisting with the use and coordination of the apparatus and the items kept within, while utilizing simple and basic storage means and methods in order to remain efficient, effective, and convenient.

The apparatus is designed to provide the user with a fast, easy, and convenient way to store, organize, and/or cook items or foods. It may also provide an enhanced storage environment with coordinated organizational means which will enable the apparatus to be completely customizable to suit a vast variety of different items. These items can then be kept neat, tidy, and arranged in such a manner to be extremely convenient to access. This organization will allow many items with different storage needs to be kept together within the same unit simultaneously. The apparatus could be rearranged at any given time, even while items of large quantity or variety are being stored. Additional enhancements could also be used to organize a storage environment such as removable, stackable, and interchangeable separators, receptacles, baskets, and trays which can be used to create customized configurations and storage setups. Certain components such as the separators could also be used as utensils to prepare items and to carry out other tasks as well. Such enhancements can also be heat resistant, microwavable, and dishwasher safe to provide easy cleaning, use, and setup.

It may be equip with vacuum pumping means which is used to create a vacuum, partial vacuum, or suction within a storage area. The vacuum or partial vacuum provides an air-free environment for items to be kept. This will keep items fresh and safely stored for long periods of time, and also retards the formation of mold and other contaminants.

Optionally, certain elements or components can be built into the apparatus to provide means to prepare items as desired. This will provide a one-stop station or facility where a user can access items and prepare them all at the same time. When accessing food items, a user can then carry out actions such as: toasting and buttering bread, making sandwiches, or slicing bagels. The type of preparations will depend on the specific type of item being stored. There are many possibilities.

Using this invention will allow a user to store, prepare, or organize all of their items or foods with the use of one apparatus or appliance. It provides a spacious enclosure which is necessary to store an adequate amount of items or foods, and provides a universal and designated storage place for them in general. The storage area is adequate for both small and large items, as well as for items of large volume. It may also function as an all in one vacuum sealing system. This will be more convenient and easier than existing means.

The apparatus can be used to store foods such as: bread, bagels, buns, muffins, donuts, pastries, cereal, chips, cookies, fruit, vegetables, and even leftovers, as well as others. It will allow these foods to be freshly stored in an efficient and economical fashion. This will prolong expiration while retaining the freshness and original characteristics or properties the foods possess.

The apparatus could be used in many environments such as: kitchens, bedrooms, or even garages, as well as a variety of other environments. It can also be stationary or built into a home, kitchen, or similar environment. It could also be used by restaurants, bakeries, or hotels, as well as others.

It may also be designed to be a portable apparatus that can be moved freely to any desired location to suit a vast amount of user needs such as: taking the unit to work, or connecting it during hotel breakfast hour, or even taking it to a picnic or cookout.

The apparatus could also be used for a variety of specific or special needs such as marinating, cooking, or freezing. It can also be used to store liquid items or foods such as: soup, spaghetti, or cottage cheese. It can also be used to store a vast array of other items and various collectables such as: medicine, cosmetics, or fishing tackle. It could also be used to keep valuables safe and secure such as: stamps, baseball cards, or comic books. There are many possibilities.

The invention may also implement the use of technology to increase its ease of use. Various electrical assistance or control can provide a wide variety of features and functions. Components such as buttons, potentiometers, and LED displays, could be used to provide interaction between a user and the apparatus, as well as others. The apparatus may also be automated in order initiate or activate functions without any user interaction at all. Many different settings or modes of operation are possible. It may also possess the ability to detect or sense the environment within a storage area. This could be used to notify a user of certain conditions of interest such as the detection of spoiled food within the enclosure. The use of “one touch” buttons and other simplified controls may also further increase its ease of use.

The object of the invention is to eliminate as many existing storage biases as possible and to provide the user with a simple, convenient, and ergonomical apparatus or appliance to provide an effective means to store their items. The apparatus is designed to suit the specific and detailed needs of a wide variety of items, while retaining their freshness. It may also aid in organization and/or preparation of these items, and provides a designated storage place for them in general. These items can then be accessed more effectively, conveniently, and frequently without hassle or burden.

### BRIEF DESCRIPTION OF THE DRAWINGS

FIG. 1—Basic view of apparatus and components

FIG. 2—Front view of apparatus with additional components

FIG. 3—Inside view of apparatus and components

FIG. 4—Exploded view of vacuum pump and air filter

FIG. 5—Back view of apparatus with hinges

FIG. 6—Exploded view of a type of rubber seal

FIG. 7—Exploded view of a second type of rubber seal

FIG. 8—Exploded view of a third type of rubber seal

FIG. 9—Front view of sliding door arrangement

FIG. 10—Side view of sliding door arrangement

FIG. 11—Exploded view of LED display and buttons

FIG. 12—Universal lid arrangement view

FIG. 13—Second universal lid arrangement view

FIG. 14—Built-in cabinet arrangement view

FIG. 15—Front view of apparatus with latching system

FIG. 16—Exploded view of latching system

FIG. 17—Exploded view of manual vacuum pump system

FIG. 18—Manual vacuum pump with pliable enclosure view

FIG. 19—Manual vacuum pump with basic enclosure view

FIG. 20—Front view of apparatus with manual vacuum pump

FIG. 21—Front view of apparatus with pump lever, external port, and attachment

FIG. 22—Electrical circuit view

FIG. 23—Inside view of apparatus with organizational means

FIG. 24—Second inside view of apparatus with organizational means

FIG. 25—View of basket with hanging means

FIG. 26—View of special basket

FIG. 27—View of magnetron with circuit and microwave heating chamber

FIG. 28—View of heating element with circuit and heating chamber

FIG. 29—View of separator storage compartments

### DETAILED DESCRIPTION OF INVENTION

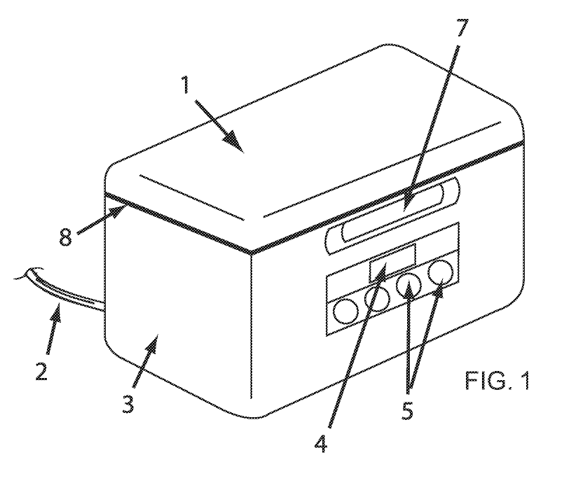

In reference to FIG. 1; The apparatus may consist of an enclosure (3) which may be contoured with a conforming lid (1), door (12), or other means for opening or closing. These means may be used in combination with a rubber gasket (8) which will form an air-tight seal. This enclosure (3) may be used to keep items for storage. A vacuum pump (17) may be used to expel air from within the enclosure (3) to form a vacuum seal. This will keep the goods fresh and retard the formation of molds and other contaminants.

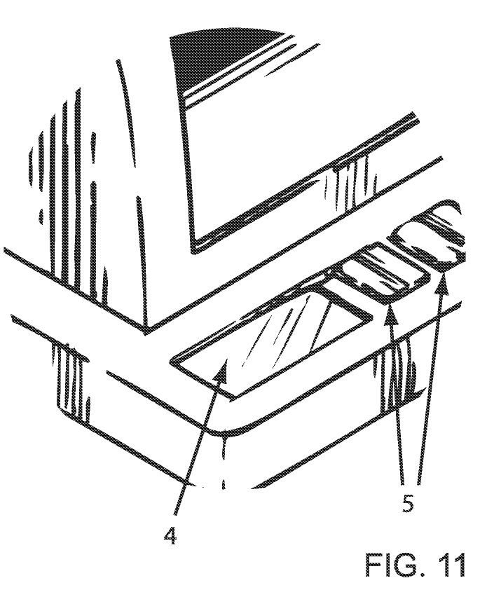

In reference to FIG. 1 and FIG. 11; The apparatus may include buttons (5), levers, or switches or an LED display (4) that will allow the user to visualize and initiate functions of the unit, such as: activating or deactivating the vacuum pump (17), setting, displaying, or adjusting the date, time, alarm, timer, or pressure, and can also be used to activate lights to enable the LED display (4) to be more visible. They could be used for other purposes as well.

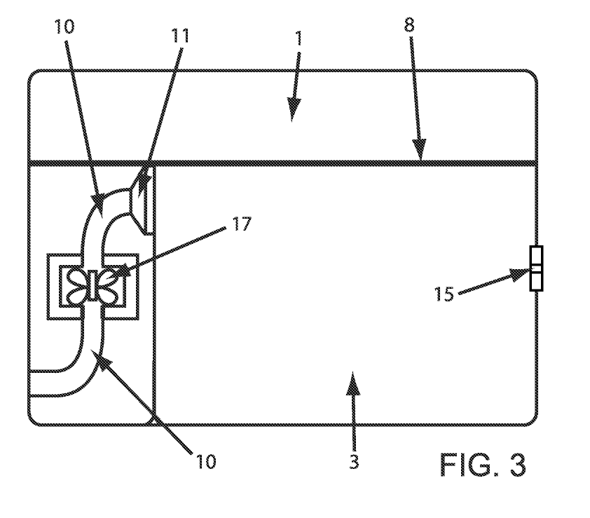

In reference to FIG. 3; The apparatus may use a vacuum pump (17) or similar suction mechanism or device (25) to expel the air from within the enclosure (3). These means are used to create a vacuum or partial vacuum within the enclosure (3). This pump (17) can either be automatic or manual. This pump (17) may also be externally connected. The storage capabilities of the apparatus could also be used without any type of vacuum or suction creating means at all and does not need to be included.

The vacuum pump (17) could be kept separate from the enclosure (3) and connected to the enclosure (3) by the use of tubing (10) or other types of airways. This will make sure that the vacuum pump (17) will not interfere with the storage space of the enclosure (3), and so the vacuum pump (17) will not be exposed to the goods. It could also be housed in a manner which enables it to operate quietly and so there is no vibration while the pump is activated.

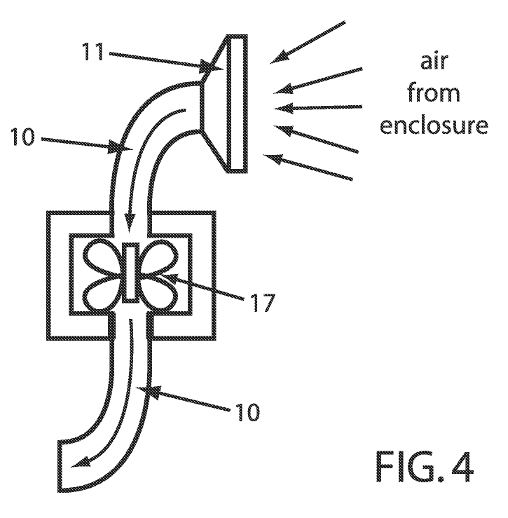

In reference to FIG. 4; When the vacuum pump (17) is activated, it causes suction to occur. This suction may draw air from the enclosure (3) by the use of tubing (10) or other type of airways. This air may need to be cleaned using an air filter (11). This will make sure that the air taken from the enclosure (3) is cleaned and won't damage the vacuum pump (17) in case there are crumbs, particles, or other unwanted elements present. In certain cases, the tubing (10) or airways may be connected to the lid (1) or other means for opening or closing, or even the seal. This will enable the apparatus to draw air from the closed enclosure (3) differently which may be useful in some cases. The lid (1) or other means for opening or closing may be able to be connected to tubing (10) or airways from the enclosure (3) thus providing means for the lid (1) or other means to remove air.

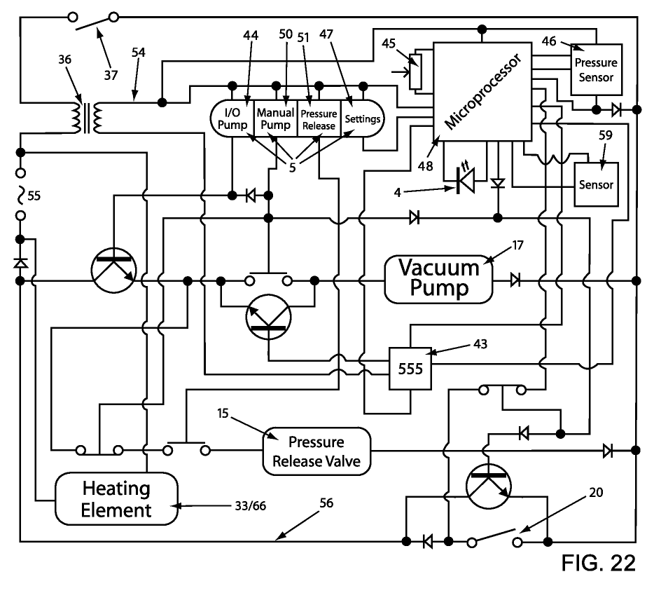

In reference to FIG. 22; The vacuum pump (17) automation could be controlled in different ways. One for example, by user automation, whereas the user could press a button (5), thus turning the power (55) on to the vacuum pump (17), or another, by allowing an electrical circuit (56) to gain precedence over its control. This automation could be displayed on the LED display (4) to inform the user the function is in automation. It could also be turned on by a timer (43) at certain times, intervals, or durations. These are just a few possibilities.

The vacuum pump (17) automation could be controlled by a timer (43), pressure sensor or vacuum/pressure switch (46). These components can detect or control when the appropriate amount of vacuum pressure has been achieved within the enclosure (3). When using a timer (43), this could be done by applying or calculating the strength and speed of the vacuum pump (17), and how much air is inside the enclosure (3), or by using, applying, or computing the electrical signals given off by a pressure sensor or vacuum/pressure switch (46).

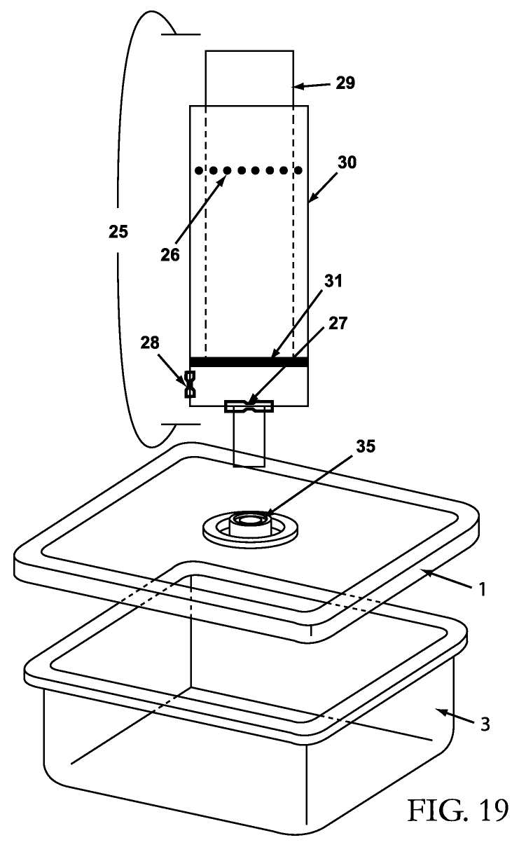

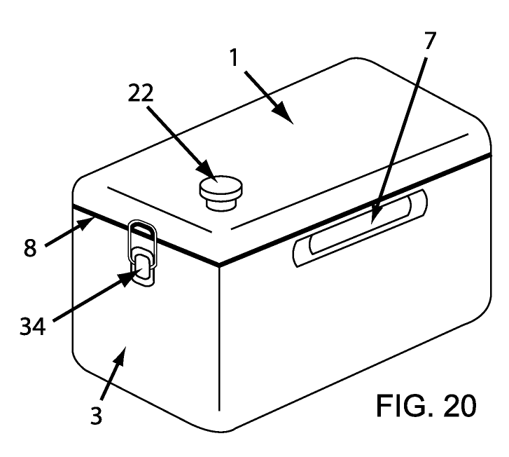

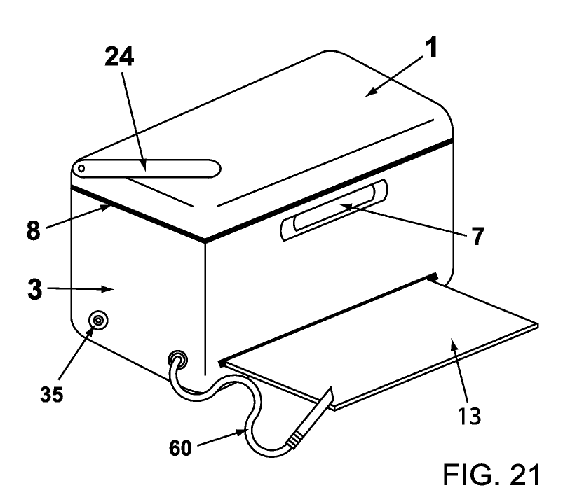

In reference to FIG. 20 and FIG. 21; The invention could use a manual vacuum pump or any similar suction mechanism (25) to expel air from within the enclosure (3) instead of an automatic pump (17). This pump (25) could be activated by hand, using a button (22), or lever (24), or other actuator. The button (22) or lever (24) could be pressed up and down or pulled back and forth to create suction which will expel the air from within the enclosure (3). Actuating the vacuum pump (25) repeatedly will make the vacuum stronger. This will allow the user to adjust the pressure to their own personal preference. The manual pump or suction creating means (25) can be of any variety or type.

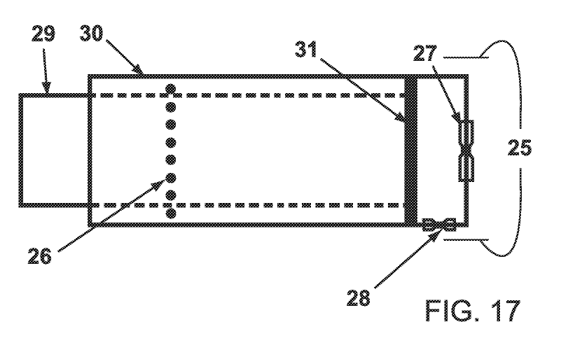

In reference to FIG. 17; One particular manual pumping device (25) may be a suction creating mechanism that uses two bodies. One body (29) may be smaller, and it can reside within or be inserted inside of the larger hollow body (30). There may be a gasket, seal, member, or rubber ring (31) connected either between or to the smaller body (29) and/or the larger body (30). This may or may not put pressure against either of the body's walls (29)(30) or be air-tight. The suction will be created when the gasket, seal, member, or rubber ring (31) or one or more of the bodies is moved back and forth, which will draw air through the intake or valve means (27). The manual pumping device (25) may be actuated by the use of a button (22), lever (24), or other actuator which will move the gasket, seal, member, or rubber ring (31) or one or both of the bodies (29)(30) back and forth, thus creating suction. The manual pumping device (25) may be connected to the enclosure (3) by a valve, unidirectional valve, or other means for air intake (27).

On the outer body (30), there may be a ring of tiny holes (26) or some other type of means for air to exit or be released. When the gasket, seal, member, or rubber ring (31) is moved past these holes (26), air can escape. It may or may not also include another valve or port (28) which could assist the pump (25) to be able to continue to be exercised without resistance or eliminate any pressure or air within the manual pump system (25). In certain cases this could also be used by itself without any additional release means. It also might be rigged to the actuator to open or close as the pump (25) is actuated. Any type of means for air release or for air to exit is possible and not limited to any specific type. The air release or exit means may also be located on the smaller or inner body (29) or located anywhere on the apparatus.

The suction mechanism (25) may be made to be stationary or removable. It may also be as part of the apparatus or be removable as part of the entire lid (1) section or other means for opening or closing. It could be housed inside the lid (1), or mounted on the underside. It could also be housed in other places on the apparatus. It should be housed or mounted in an efficient place as to not interfere with the items being kept inside the enclosure (3) as well as making it a convenience to operate.

In reference to FIG. 19 and FIG. 21; A vacuum pump (17) or suction mechanism (25) doesn't have to be built into the apparatus. It could also be used externally. In this case, the apparatus could simply have a built-in valve (35) of some type so that an external vacuum source can be connected to the valve (35) at any time to pump the air out of the enclosure (3).

The vacuum pump (17) may be used to merely communicate with a storage area. This is to fully utilize the capabilities to its fullest extent and highest possible performance.

The suction created by a vacuum pump (17) or suction mechanism or device (25) could also be used for other purposes such as cleaning the apparatus. Vacuum tubing (60) could either be built-in or connected at any time to provide suction means to pickup particles of matter such as crumb, remnants, and other such wastes.

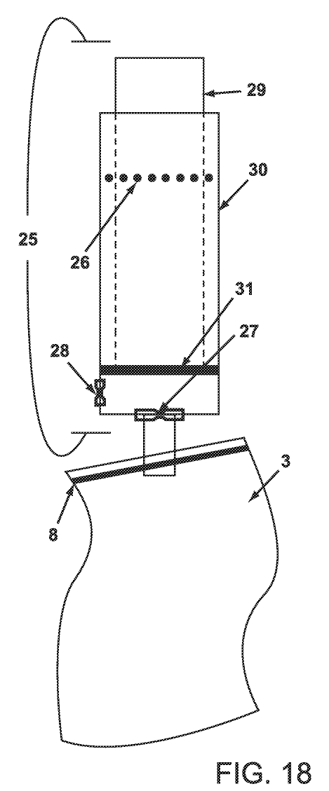

In reference to FIG. 18; A vacuum pump (17) or suction mechanism (25) could also be used to remove or expel air from a pliable or flexible enclosure (3) such as a bag. This pliable or flexible enclosure (3) may have a pliable or flexible seal as well. It may or may not have a valve (35) or a seal made from rubber (8).

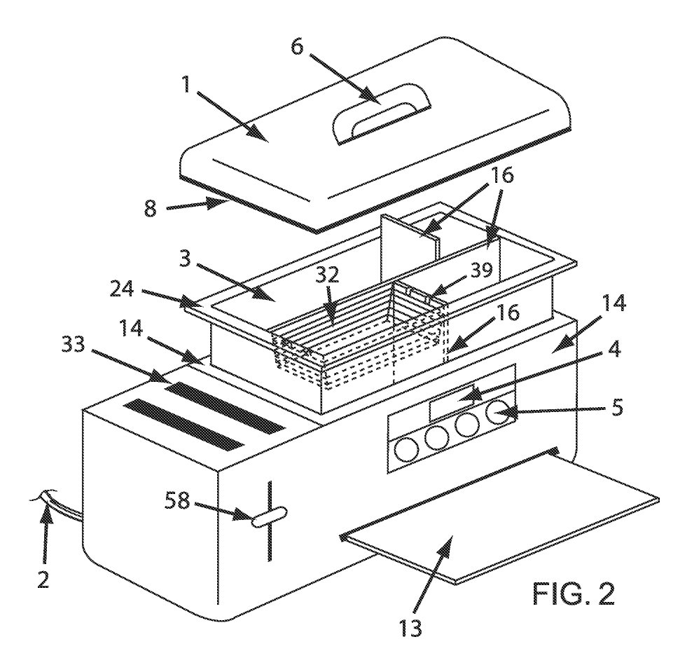

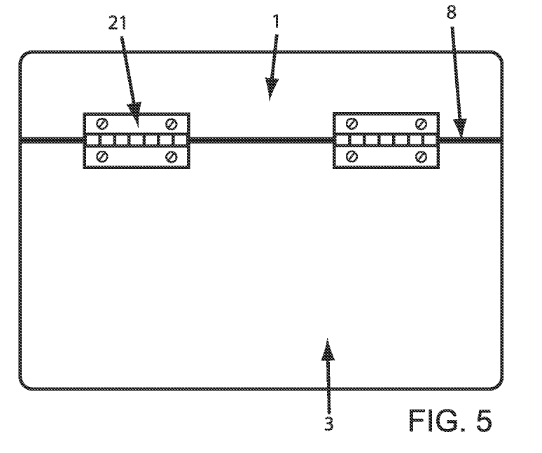

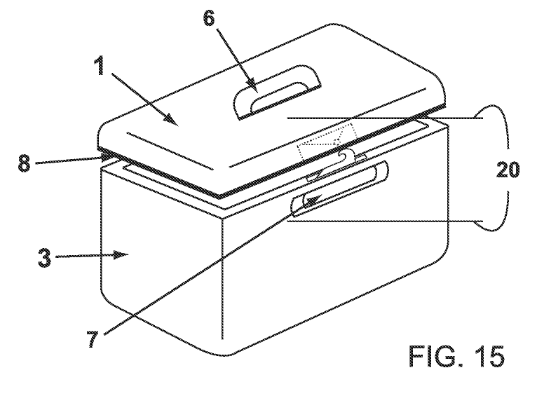

Gaining access to the enclosure (3) may be done using many methods. The enclosure (3) will need to be opened in order to access the items housed within. In reference to FIG. 5; the lid (1) may or may not be connected to the rest of the apparatus using hinges (21). In reference to FIG. 2 and FIG. 15; the lid (1) could also be detachable. The apparatus may or may not use a handle (6) to enable the user to apply leverage to the lid (1), thus making it easier to open the enclosure (3).

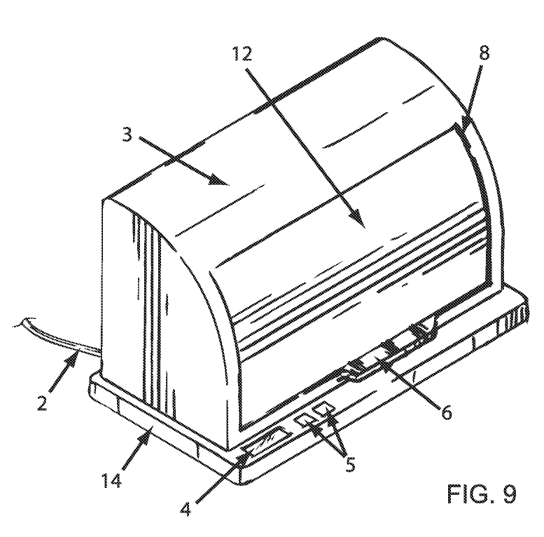

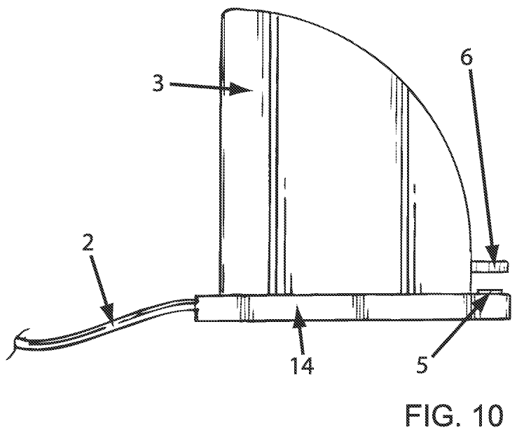

In reference to FIG. 9; The user could gain access to the enclosure (3) using a sliding door (12). This could be made with contoured plastic or other material, or even with a section that has foldable characteristics. This sliding door (12) may or may not also benefit from the use of a handle (6).

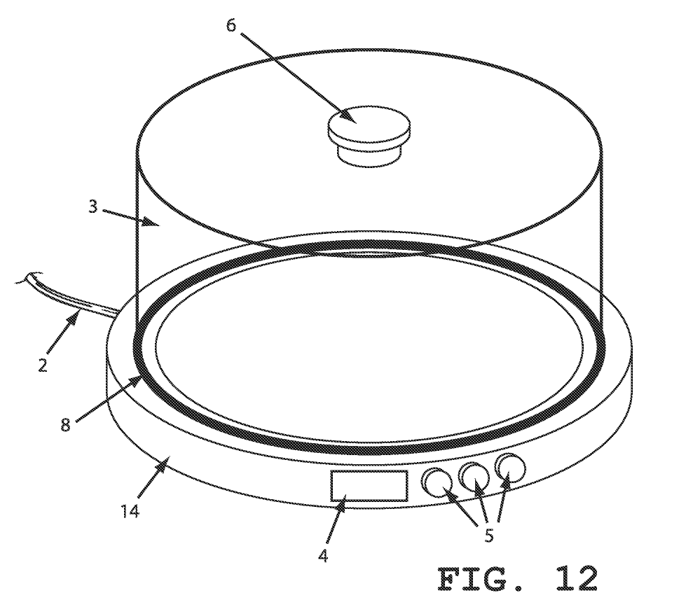

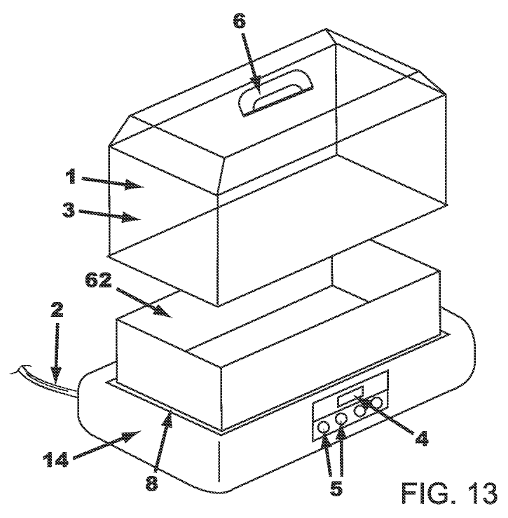

In reference to FIG. 12 and FIG. 13; The apparatus could have a lid (1) and the enclosure (3) act as one object. This will enable a user to lift up the entire enclosure (3) to gain access to the goods. This lid (1) or enclosure (3) could be made of clear plastic as well. The rubber seal (8) would be underneath the enclosure (3), thus allowing gravity or other means to aid in the enclosure's (3) seal. The apparatus's components could be housed inside the base (14), or elsewhere, and to not interfere with the enclosure (3). A plastic casing (62) could be used around the inner rim of the enclosure (3). This will prevent items from falling over when the enclosure (3) is opened, while providing guidance for the lid (1) or enclosure (3) when it's being closed.

Various parts of the apparatus could be made of clear plastic or contain a clear window to allow the inside to be visible such as a lid (1) or door (12), or the entire apparatus itself could be clear. This will enable a user to view the enclosure's (3) contents before opening or unsealing it.

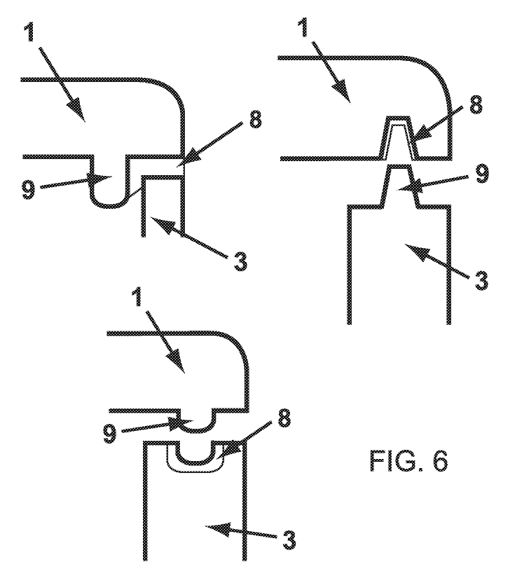

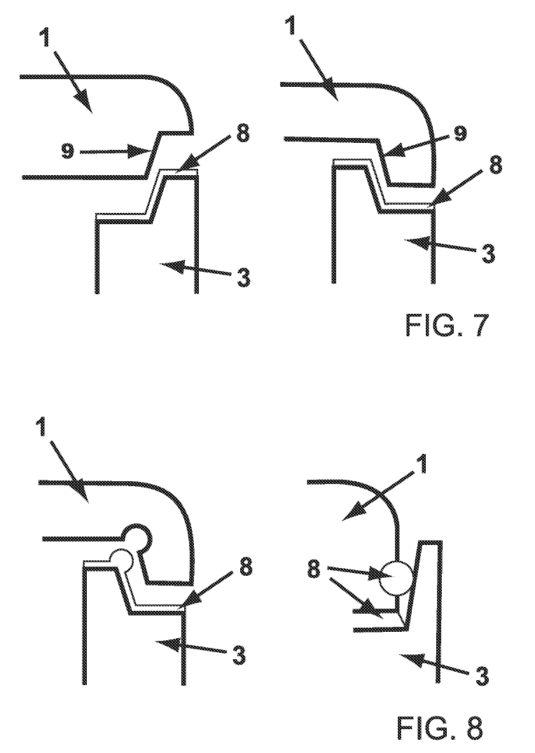

In reference to FIG. 6, FIG. 7 and FIG. 8; In order for the enclosure (3) to contain the vacuum pressure, the seal must be air-tight. This could be achieved using a rubber seal (8). When the enclosure (3) is closed, the rubber seal (8) will form an air-tight gasket. This rubber seal (8) could be attached to either the lid (1) or to the rim of the enclosure (3). When vacuum pressure is applied with this rubber seal (8) in place, it will contain the pressure and keep the enclosure (3) vacuum sealed, thus providing an air-free environment for items to be kept. This rubber gasket (8) can be FDA approved to be in contact with foodstuffs or other items and can be safe for cleaning as well. The seal is designed to be simple and practical. The apparatus will be opened and closed frequently, thus making the need to keep the seal simple and easy to open. This seal (8) can come in a variety of orientations to suit any particular shape or style of enclosure (3).

In reference to FIG. 6; Either the underside of the lid (1), or the perimeter of the enclosure (3) could contain a protruding lip or rim (9). This lip or rim (9) could be used to receive or hold the lid (1) so that the seal (8) forms a snug air-tight fit each time it is closed. The notch or opening of the rubber seal (8) could be slightly smaller than the lip or rim (9), so that when the lip or rim (9) is inserted into the rubber seal (8), the rubber seal (8) will squeeze and grip the lip or rim (9). The pressure or tightness created between the lip or rim (9), rubber seal (8), and/or enclosure (3) will aid in this grip, which will provide an air-tight seal.

In reference to FIG. 7; The lip or rim (9) is a flat section that puts pressure on the rubber seal (8) when the lid (1) is closed. This lip or rim (9) could have either a slightly larger or smaller perimeter than the inside perimeter of the enclosure (3) depending on the desired orientation, thus causing significant pressure between the lip or rim (9) and the rubber seal (8). This method can be compared to how a beverage cooler would close.

In reference to FIG. 8; Additional security could be added to the lid (1) by having a notch or indentation formed into the lid (1) that would receive a bulge of rubber seal (8). The rubber seal (8) would be squished or pressed into the notch by the pressure of the lid (1) being closed. The lid (1) would be held securely closed because the rubber seal (8) won't slip out of place unless a significant amount of force is applied to open the lid (1). Other additional or different security measures could be used as well.

A rubber seal (8) is formed around the perimeter of the lid (1). When the lid (1) is closed, it will slide into the top of the enclosure (3). The inner rim of the enclosure (3) can be angled so that the lid (1) is received with ease. When downward pressure is applied to the lid (1), it will create pressure between the rubber seal (8) and the inside of the enclosure (3), thus creating an air-tight seal capable of containing vacuum pressure.

In reference to FIG. 19; A seal could also be achieved without a rubber seal (8) or without the use of any additional material in place whatsoever. This seal may or may not be air-tight. The seal could be achieved merely by closing the enclosure (3) like any basic or standard enclosure or container would close. The way in which the means for opening or closing mates with the enclosure (3) will create a natural seal and the enclosure (3) will remain closed.

In certain cases where the seal will need to contain vacuum pressure or be air-tight, the seal may need to be stronger or more durable. This could be done in a variety of different ways. For example, the pressure between the means for opening or closing and the enclosure (3) or it's walls could be strong or substantial enough to be air-tight. This method could be compared to how a beverage cooler would close. Any method or type for creating a seal can be used and not limited to any specific version. The way in which the seal is achieved will depend on the type and shape of the enclosure (3) and means for opening or closing. These components could be any shape so that any type of seal is possible.

In reference to FIGS. 3 and 22; When the vacuum seal needs to be released the apparatus may use a vacuum release valve or release valve system (15). This may be controlled or actuated by a button (5) or similar mechanism that the user can activate at will. It could also be actuated by other means. Upon activation, a valve (15) will open to allow air to flow into the enclosure (3), and thus releasing the vacuum pressure and enabling the apparatus to be opened safely and easily. The vacuum release valve (15) may or may not be controlled by or make use of the electrical circuit (56). This valve (15) may also use an air filter (11) to make sure the air is cleaned prior to entering the enclosure (3). This release valve or release valve system (15) may be separate from the rest of the other mechanisms, or it may even be part of the latching system's (20) automation. For example, when the user presses or pulls the latching handle (7) to open the lid (1), the release valve (15) will open. The apparatus may not need to use a release valve (15) at all. It may depend on the intensity of pressure contained inside the enclosure (3). The pressure could also be released without such means.

In reference to FIG. 15; A latching mechanism or system (20) may be used to help hold the means for opening or closing closed. It may also strengthen the seal by adding pressure between the means for opening or closing and the enclosure (3). In certain cases, the seal (8) may be tight or even difficult to open. The latching mechanism or system (20) may also aid in the release of the lid (1), door (12), or other opening means and can help the user to open the enclosure (3) easily and safely. This may be done either before or after the vacuum pressure has been released. This mechanism (20) may also have the ability pop the enclosure (3) open. Popping the enclosure (3) open can provide assistance, where a user does not have to apply leverage or exert themselves in order to open the enclosure (3). Any type of latching means (20) can be used and not limited to any specific type or orientation.

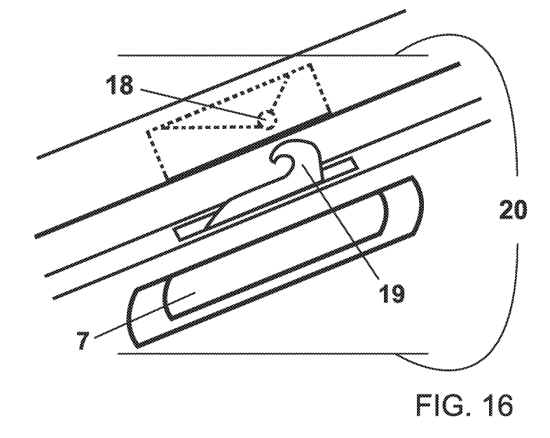

In reference to FIG. 16; One version of a latching system (20) may simply be a hook (19) that is held shut by a pin (18). Either the hook (19) or pin (18) could be moved by pressing or pulling a lever or handle (7), which will cause the latch to open, thus allowing the apparatus to open. The lever or handle (7) could use a spring(s) to add leverage or resistance to the system. While the lid (1) is being closed, the hook (19) or pin (18) can simply slide into a locked position without being depressed.

An opening mechanism may be a part of the latching system (20). With the aid of one or more spring(s), the mechanism could pop the apparatus open when the latching handle (7) is pressed or pulled.

The latching mechanism (20) may also activate the vacuum release valve (15), which will allow air into the enclosure (3). Other assisted opening means could be used as well. This may be helpful if the enclosure (3) contains more substantial amounts of pressure. It could be used for safety purposes.

The entire system (20) could be completely automated by pressing or pulling the latching handle (7). When the latching handle (7) is pressed or pulled, it can release the pressure within the enclosure (3) via the release valve (15), while releasing the hook (19) from the pin (18) causing a spring(s) or other means to open the apparatus for the user. This assisted means to open the apparatus will enable it to be easy to use.

In reference to FIG. 20; Another version of a latching system could simply use clasp(s) (34) to secure the lid (1). Depending on the placements of the clasp(s) (34), the lid (1) may or may not use hinges (21). There maybe variations to the latching system (20) or latching system orientation. The apparatus may not use a latching system (20) at all.

In reference to FIG. 1; This apparatus could get its power (55) from a standard power cord (2). This electricity will be used to power the components of the apparatus. This power cord (2) could be detachable, or it could also be stored in a special compartment for storing the cord. This will help when the apparatus is being moved. It could also be retractable. Any type of power such as batteries, could be used instead of a power cord (2).

In reference to FIG. 22; An electrical circuit (56) could be used in the apparatus. This could control a variety of different functions and regulate, control, or calculate a variety of different factors. An electrical circuit (56) can be used as the control center for the entire apparatus. This circuit (56) could be made up of a variety of different electrical components such as: timer(s) (43), pressure sensor(s) (46), vacuum/pressure switch(es) (46), spoilage or environment sensor(s), actuator(s), switch(es), button(s) (5), lever(s), and LED Display(s) (4), as well as other circuit components. These components could be regulated by the use of circuit board(s) and by using basic electrical circuit board components such as: relay(s), diode(s), resistor(s), capacitor(s), transistor(s), potentiometer(s), and IC(s) or integrated circuit(s), as well as others. All of these electrical components used together could control the apparatus functions such as: turning the vacuum pump (17) on/off, releasing the pressure within the enclosure (3), displaying the date and time, displaying the automation of functions, allowing user automation over functions, as well as controlling certain functions without the need for user automation, as well as others. For example, when the user would like to open the enclosure (3) to gain access to the items within, they would press a button (5), which would activate the vacuum release valve (15), thus releasing the vacuum pressure within the enclosure (3). For example, when the user closes the apparatus, this will trigger the vacuum pump (17) to turn on, thus resealing the enclosure (3) with pressure. For example, when a user would like to adjust the time or date, they would press a button (5), thus changing the time or date reading on the LED display (4). These are just a few possibilities.

The circuit (56) is powered by a source of power (55). The circuit (56) may or may not be turned on by a main I/O switch (37) which is used to complete the circuit (56) which allows the components to have access to the power (55). Once the components receive power (55) the apparatus's functions can be used.

Components that may require lesser amounts of current may get power (54) from a transformer (36). A transformer (36) can reduce the current for this purpose, and could be used to power things such as microprocessors (48) or other integrated circuits (46)(43)(5) which require less power. The buttons (5)(44)(50)(51)(47) could also use this power (54) to initiate functions. Other areas of the circuit (56) could also use this power (54). A transformer (36) could also convert the electricity or current from AC to DC or DC to AC.

A microprocessor (48) may be used to control functions of the entire circuit (56). It could receive signals from the pressure sensor or vacuum/pressure switch (46), 555 timer (43), or other components. It receives, uses, or computes such signals to control apparatus functions. It may also be used in combination with a potentiometer (45), buttons (5)(44)(50)(51)(47), or with other components to control various functions like turning the vacuum pump (17) on or off, to release pressure from the enclosure (3), or to change internal settings that control things such as: date, time, alarm(s), vacuum pressure, speed, duration, interval, or an LED display(s), to name a few. It could also hold data and/or also function as or with memory. It could also be used for other reasons.

Processing means other than a microprocessor (48) may also be used. The circuit (56) may not include a microprocessor (48) or any processing means at all. A circuit (56) could also use raw electric signals, processing, or circuitry to operate instead of using a microprocessor (48).

In reference to FIG. 11; An LED (4) may be used to display date, time, and the various use of functions, as well as other information or data. This LED (4) could remain in display at all times. It could be used to display the use of various functions. For example, for visual purposes, it could display a pressure reading taken from within the enclosure so that a user can adjust the vacuum to a desirable amount. This could automatically display when a button (5) is depressed, or it can display automatically when the vacuum pump (17) is turned on. It could also display or indicate when the enclosure (3) is open, or perhaps to indicate that the pressure within the enclosure (3) has been successfully pressurized or when it has been fully released and is safe to be opened. It could also be used for other reasons, such as to provide visibility inside the enclosure (3). These are just a few possibilities.

In reference to FIG. 22; A pressure sensor or vacuum/pressure switch (46) could be used to determine or control the appropriate amount of pressure within the enclosure (3). When used in combination with a timer (43), microprocessor (48), or other components, it could also be used to control the amount of pressure the enclosure (3) receives. With the aid of a potentiometer(s) (45), the vacuum pressure that the enclosure (3) receives could be adjusted. It could also be used to tell the vacuum pump (17) when to shut off, as well as automatically turning on the vacuum pump (17) at or for certain intervals, durations, or times. The pressure sensor or vacuum/pressure switch (46) may be initiated, activated, or engaged when negative pressure has been created within the enclosure (3). It could also be activated or applied in different ways. It could also help determine whether the seal (8) is leaking pressure by displaying it with an LED (4), where then it would be known and the apparatus could then be serviced or replaced.

The apparatus could make use of many logistics that can be determined by the use of a pressure sensor(s) (46). These logistics can enable many useful features for the apparatus while also providing means for automation. It could also be used for other reasons.

An integrated timer circuit, 555 timer (43), or similar circuit may be used to keep time on various elements such as: date, time, alarms, timing, and pressure, just to name a few. When used in combination with a microprocessor (48), it could be used to apply functions used by the apparatus. It may also assist with many variables and factors which the apparatus could use. For example, it could be used to provide timing means to keep a vacuum pump (17) on or in use for a certain duration. It could also be relied upon to directly regulate or initiate use of functions such as: turning on the vacuum pump. This could be achieved without the use of a pressure sensor (46) or any means for processing. It could also be used for other reasons. Other timer means besides circuit controlled means could also be used.

The latching system (20) could be used as a switch, which when opened or closed either breaks or completes the circuit (56), thus enabling or disabling the apparatus's use of power (55) or certain functions. For example, if the latching system (20) is open, the circuit (56) is off. If it is closed, the circuit (56) is on. If the latching system (20) is open, it means that the enclosure (3) is open and the apparatus is in use which could disable all unwanted operations from being used at inappropriate times. Furthermore, when the latching system (56) is open or closed, it could regulate the use of the vacuum pump (17) or pressure release valve (15). For example, when the apparatus is closed, the vacuum pump (17) is activated which will pressurize the enclosure (3) or when the latching system handle (20) is depressed, it could activate the pressure release valve or solenoid valve (15), which will release the pressure within the enclosure and open the apparatus. There could be variations to this feature.

The vacuum pump (17) could be turned on or off by the use of the I/O pump button (44). This button (44) can shut off any or all use of the vacuum pump (17). This is a useful feature when a user would like to use the enclosure (3) for storage without using the pump (17). For example, if the user will be opening and closing the unit many times very frequently, they could easily just turn the pump (17) off. This would be more efficient than allowing the unit to pressurize each and every time between each use. For example, this feature could be used at breakfast time, where use of the unit would be repeatedly opened in a short duration. This button (44) could also be used as a safety or security feature. It could also be turned off to save electricity and resources. It could also be used for other reasons as well.

A manual pump button (50) could be used to manually switch the vacuum pump (17) on for a desired duration. This button (50), when depressed will manually turn on the vacuum pump (17). It may be able to override the I/O pump button (44). This is especially useful when the vacuum pump (17) is turned off. This will enable the user to be able to seal the enclosure (3) at will. This button (50) may turn on the vacuum pump (17) only for the duration that the button (50) is being depressed. It could also be used in other ways or for other reasons as well.

A pressure release button (51) could be used to release the pressure from within the enclosure (3). This button (51) will enable a user to release the pressure manually without having to actually open the enclosure (3). This can be helpful when there is large amounts of pressure present within the enclosure (3) which may be too difficult or strenuous to open, which could be a safety concern. It may be more appropriate to first release such pressure, which would then safely and effectively enable the enclosure (3) to be opened. It could also be used as a safety or security feature that is used to release the pressure within the enclosure (3). An electrical circuit (56) could also automate its use. It could also be used in other ways or for other reasons.

A settings button (47) could be used to display or change various features of the unit. For example, it can be used for changing the date or time, or it can be used to change internal settings for the desired pressure level, or to deactivate the spoilage alarm. It could also be used to turn on an LED (4). These are just a few possibilities.

The vacuum pump (17) could be controlled in a variety of ways. The way in which it is utilized may depend on the specific needs of the apparatus. The pressure sensing or vacuum/pressure switch (46), processing, timer (43), or other means could activate or invoke the vacuum pump (17) or the pumping process at any time. It could also be controlled or activated by a raw electric intermediary or controller. There are many possible variations, orientations, or sequences in which the circuit could use in order to utilize the vacuum pump (17), or other components and not limited to the use of any specific component(s), type, or method.

Components could be substituted with similar components that serve the same or similar purpose(s). The way or orientation to which the components are connected or associated may be different as well. It may not be necessary to use any or all of the components to achieve any or all tasks or operations. It may also be desirable under certain conditions or circumstances to use any or all of the components differently or use different methods in order to carry out or use any or all functions or operations. There are many possible variations that will be specific to the particular version of the apparatus. Operation of the apparatus or certain tasks of, could solely rely upon raw or preprocessed electric signals or circuitry, unprocessed signals, or signals processed by means other than by a microprocessor. It may or may not be relied upon to use signals transmitted by a sensor or other informational aiding component. The apparatus could even operate manually without any need for such means or without any automation at all. For example, the vacuum pump could be initiated by the user at a time in which they desire to do so. There are many possibilities and the many variations are pertinent to the specific needs of the user or apparatus.

Many logistics could be made by the use of a variety of components. These logistics may be used for various other reasons and to create features appropriate for the apparatus.

The apparatus does not have to include any or all of the components in order to provide adequate electrical means. Any type of electrical means can be used to operate the apparatus and is not limited to any specific type or method. The electric means or circuit may also possess the ability to carry out or complete one or more certain or specific operations with one or more components that communicate with one or more components that are aside from any in which had previously communicated. For example, the vacuum pump can be activated by a sequence of components that are connected and communicate in a unidirectional manner.

Other buttons or components could also be used as well to achieve things such as: adjusting or customizing ways, settings, or methods in which the apparatus operates or uses functions. They could also be used to optimize the apparatus to a desired degree, or to turn on/off certain functions not being used. They could be used for other reasons as well. There are many possibilities.

In reference to FIG. 9; Certain simplified buttons (5) or components could also provide means to be extremely easy to use such as “one touch” buttons (5), where a user merely has to press or engage them a single time in order to carry out a function or operate the apparatus to a desirable degree.

The apparatus could also be used without any electricity, circuitry, or any associated components at all. The basic storage means and capabilities could be equally as effective to use.

The apparatus may or may not include certain preparation means. These means will allow a user to prepare the items kept with the apparatus to a desirable degree. Any type of preparation means can be used and not limited to any specific type. The type of means used will be pertinent to the specific needs of the user or the apparatus.

In reference to FIG. 2 and FIG. 21; This apparatus could also include slide-out tray(s) or slice(s) (13). This item can function as a cutting board or plate (13), so a user can slide this section out and provide a place to prepare the items or goods and to perform actions such as: making sandwiches, cutting bagels, or buttering bread, to name a few. This cutting board or. plate (13) will ensure that counter-top or table surfaces will not get damaged by knives. It will also ensure that the crumbs or mess left from the preparation is not spilled onto counter-top or table surfaces.

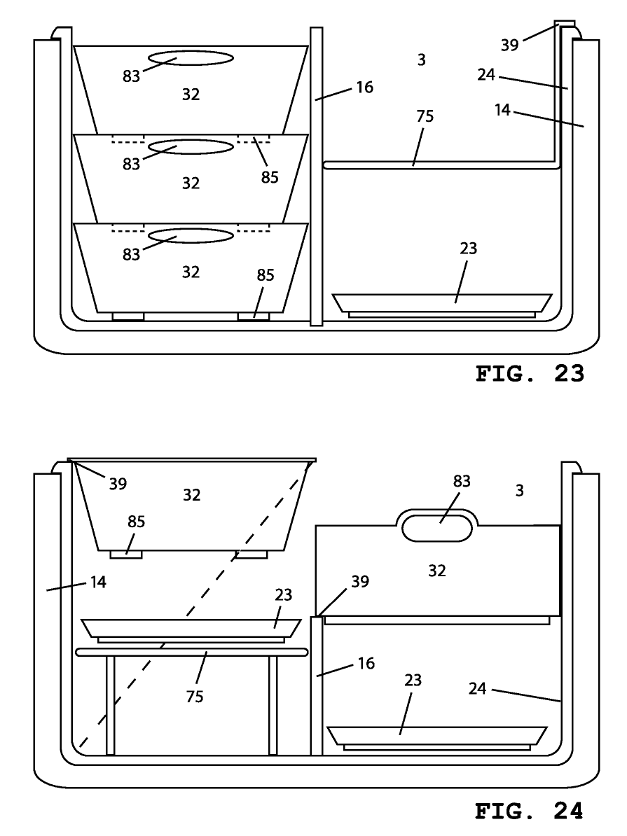

In reference to FIG. 2, FIG. 23, and FIG. 24; The apparatus may include slide-out separator(s) (16) which can aid in organization. The separator(s) (16) could slide into notches or slots that are formed on the inside walls of an enclosure (3) and can be removed or reorganized at will. This will enable many possibilities for the enclosure to be organized in ways to suit many types of items. This will create a fully customizable environment which can be used to store a vast variety of different items simultaneously within the same enclosure (3). The separator(s) (16) could also come in different sizes to enable the user to personalize the enclosure (3) to suit their needs. The separator(s) (16) could also be used as cutting tools or other useful utensils. For example, they could be tapered to provide a “sharp” edge for cutting. For example, you could cut things such as: toast, English muffins, or bagels in half. This could come in handy when used in combination with the cutting board (13). The separator(s) (16) could also be used as a cutting board(s) (13) themselves.

The separator(s) (16) may be shorter than the height of the enclosure (3). This will ensure that plenty of air circulation can occur within the entire enclosure (3), and that when the vacuum pump (17) is turned on, the separators (16) aren't blocking any air paths, and so they won't deter components or sensors from working or getting an accurate reading. They could also be high enough so that stacked food items will not fall over into other designated areas.

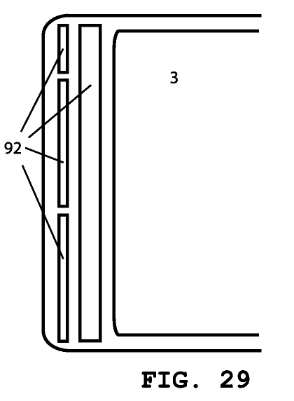

In reference to FIG. 29; The separator(s) (16) could be stored in one or more specially designated area(s) or compartment(s) (92). The compartment(s) (92) could be located practically anywhere in the housing (14), or within the enclosure (3), lid (1), or elsewhere. The many different sizes or shapes of separator(s) (16) could fit into the compartment(s) (92) with ease and could be taken out and used as needed. The separator(s) (16) which are used as utensils or cutting tools could be stored in an easily and conveniently accessible compartment (92).

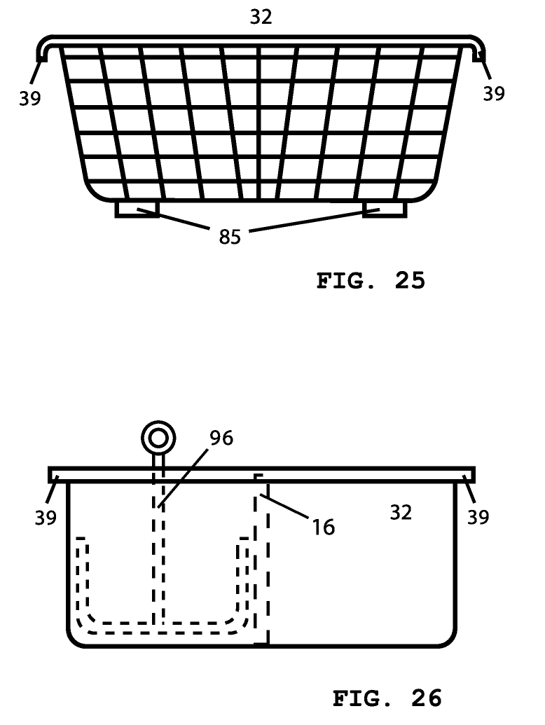

In reference to FIG. 2, FIG. 25, and FIG. 26; The apparatus may also include one or more ergonomically designed basket(s) or dish(es) (32) for the inside of the enclosure (3). The basket(s) or dish(es) (32) can serve many useful purposes and will also provide another way to completely and conveniently arrange, organize, or customize an enclosure (3) to suit many possibilities.

The basket(s) or dish(es) (32) can be used to store a wide variety of items with different characteristics such as: shape, size, and style. For example, a basket (32) designed to hold a loaf of bread, or a basket (32) designed to hold a stack of English muffins or bagels, or a dish (32) of cookies or cereal. Any type of receptacle(s) can be used.

They may be removable so that they can be taken out of an enclosure (3) and put back at will. For example, a basket (32) containing a loaf of bread could be taken out to be placed onto a kitchen table for dinner. The basket (32) is easily accessible and can then be replaced back into the enclosure (3) and stored for later use. The basket(s) or dish(es) (32) could be used for storing supplementary or short term items such as: left over chips or a few left over donuts, where the basket could be removed and washed instead of having to wash an entire enclosure (3) which is already filled with a lot of food. They can also keep items from coming in contact with the bottom of an enclosure (3). This will make sure that the items do not come in contact with any crumbs or mess that was left from the enclosure's (3) previous contents. There are many uses.

There may also be a removable enclosure (24) whereas the entire enclosure (3) itself with it's contents could be removed similarly to the basket(s) or dish(es) (32). This removable enclosure (24) may also come in a variety of different shapes so that they will be able to be switched at any given time in order to provide different configurations for the apparatus. For example, a removable enclosure (24) which is designed to hold two loaves of bread could be replaced with one that holds six different kinds of cereal. The removable enclosure(s) (24) could come in a variety of different shapes, sizes, and configurations.

In reference to FIG. 23, FIG. 24, and FIG. 26; The basket(s) or dish(es) (32) may be stackable so that many layers of storage can be used within the enclosure (3). They may also be equipped with feet (85) which can define how they sit on top one another or how they fit together. The basket(s) or dish(es) (32) may be made to accept the feet (85) of the top baskets so that they form a secure, stacked, and solid arrangement. This will aid in organization and allow the enclosure (3) to be coordinated so that it can be easily accessible while still fully utilizing the entire storage capacity. It will also provide diversity to an enclosure (3) so that many non-related or different items can be kept together simultaneously.

In reference to FIG. 2, FIG. 25, and FIG. 26; Certain basket(s) or dish(es) (32) may be equip with hooks or support (39) for hanging purposes so that they can be hung on the walls of the enclosure (3) or from separator(s) (16).

In reference to FIG. 23 and FIG. 24; Basket(s) or dish(es) (32) may be sized or shaped in a way so that they are able to slide in and out or be removed with ease. They could be equip with handles (83) to allow them to be easily removed or transported, and it would also allow better accessibility of other areas of the enclosure (3). Retrieval and stocking of items will then be easier, more organized, and more coordinated. They could also be sized or shaped in a way to fit within other basket(s) or dish(es) (32).

Rack(s) (75) may be used to create plateaus within the enclosure (3). They may also be stackable in a similar fashion as the basket(s)/dish(es) (32). This will enable a user to create layered arrangements which also aids in organization and coordination of the enclosure (3). Rack(s) (75) with feet may also be used for creating plateaus and layers which can be stacked over items so that different items can be stacked on top, thus keeping them separate. The rack(s) (75) may also be equip with hooks or support (39) to be hung in the same manner as the basket(s)/dish(es) (32).

In reference to FIG. 26; Special basket(s) (96) could also be sized or shaped in a way to fit within other basket(s) or dish(es) (32). Rack(s) (75) could also be used in the same manner. The basket(s) or dish(es) (32) may also contain slots or notches so that the separator(s) (16) may fit into them further customizing storage and organization means.

In reference to FIG. 23 and FIG. 24; The apparatus may also include removable tray(s) or plate(s) (23) that fit within the enclosure (3). The tray(s) or plate(s) (23) can be used to set items on, and so that they can be removed from the enclosure (3) at any time. They can be used to keep the bottom of the enclosure (3) clean and to prevent remnants or debris from accumulating. For example, a tray (23) is used to catch crumbs from a loaf of bread or to prevent sticky donut residue from coming in contact with the enclosure (3). When a user would like to empty the tray or plate (23), they can simply remove it from the enclosure (3), dispose of any mess and clean it with ease. The tray(s) or plate(s) (23) will aid in sanitation and cleanliness. They could also be stackable for added convenience, and can serve a variety of other purposes.

When used in combination, the basket(s)/dish(es) (32), rack(s) (75), or tray(s) (23) can create a fully customizable and enhanced storage area. It will allow a user to organize the enclosure to suit a vast array of items. Any desired arrangements, configurations, or setups could be used to streamline the storage environment to it's fullest potential and capacity. They can come in a variety of different shapes, sizes, and styles to suit many different items.

In certain instances, the apparatus may also benefit from the combined use of one or more other household appliances. These appliances may be built into the apparatus or connected separately.

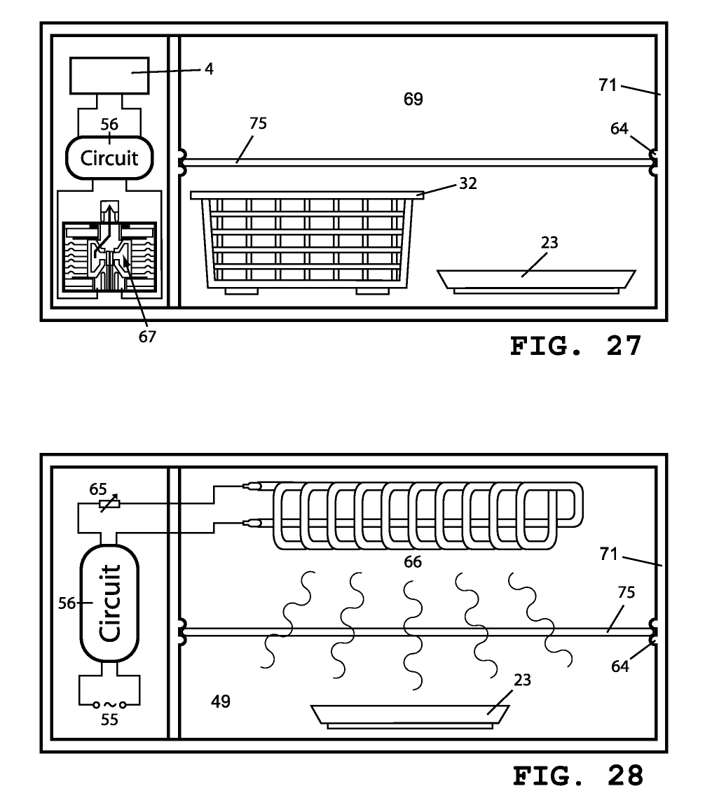

In reference to FIG. 2, FIG. 27, and FIG. 28; Certain appliances may be built-in or connected at any time to the apparatus in order to provide heating means so that a user can heat items such as: a heating element (66) or other heat creating device. For example, a toaster (33), toaster oven (49), or microwave oven (69) equip with a magnetron (67) could be built-in, to name a few. In certain cases, this can provide the user with a one-stop station to prepare items with heat that would typically kept within the enclosure (3).

Also, such appliances may or may not have an impact on an environment within the enclosure (3). In some cases, it might be useful to be able to use such means with or within an enclosure (3). For example, the enclosure (3) could be used to both store and heat items. A combination compartment such as this could be coordinated to be used accordingly where or when such means are desirable or necessary. There are many possibilities depending on the type of appliance or heat creating means being used.

In reference to FIG. 27; The apparatus may be equip with a magnetron (67) which can be used to warm or heat certain items. The intensity of the heat generated by the microwaves produced by the magnetron (67) could also be controlled by a circuit (56). This intensity may vary greatly from that of standard or conventional microwave ovens which are used to cook frozen, denser, or bulkier items. The amount of heat needed for certain heating tasks may be substantially less. In many instances, it would not be desired or intended to cook or heat the items any further, but merely to warm them or make them soft, or to perhaps make condiments, spreads, and other additions melt such as: butter, peanut butter, or icing. A great degree of heat however could also be appropriate. For example, a fresh loaf of Italian or French bread could be heated for dinner.

In reference to FIG. 28; The apparatus may be equip with a toaster oven (49) which can warm, toast, or heat certain items. The heat generated by the heating element (66) can provide means to prepare items to a desired degree. The intensity or duration of the heat may be adjustable, similar to any standard or conventional toaster oven.

Functions of built-in appliance(s) could be activated or controlled by the use of a circuit (56) or various controls. Components such as potentiometers (65), buttons (5), or levers (58) could be used to adjust or control the intensity, duration of use, or other various functions or factors. For example, in reference to FIG. 2; the toaster (33) could be activated by the use of a toaster lever (58). The circuit (56) may or may not be connected to the same circuit (56) which controls the use of other apparatus functions such as the vacuum pump (17). For example, The magnetron (67) could be activated via the circuit (56) or by other buttons or controls (5) that are specifically designated for the magnetron (67) or microwave oven (69). A separate LED display (4) may also be used to display the use of functions and settings specifically for such built in appliances.

The same basket(s)/dish(es) (32), rack(s) (75), or tray(s) (23) that are used within the enclosure (3) to organize items could be used with the built-in appliances. They may also be made of suitable materials to withstand the effects of heat, microwaves, and/or other variables such as dishwashing. This will aid in coordination and convenience when using the apparatus.

The apparatus may or may not use any means for organizing or coordinating the enclosure (3) or any means for preparation. It depends on the particular version of the apparatus and the specific needs of the user.

The apparatus and it's components could be made of any type of material and not limited to any specific type. Different use of materials might have an impact on the characteristics or authenticity of certain items kept within. For example, metal might have an impact on things such as: flavor, aroma, or taste. Use of materials could also affect certain variables such as moisture, humidity, or other important factors within the enclosure (3) or other areas of the apparatus. It could be made mostly of plastic which could be formed by the use of plastic injection molding or similar plastic forming methods. This will provide a smooth and safe area for the items to be stored, and to enable many different shapes, styles, and sizes to be created to make effective designs and enable the apparatus to fit into a variety of environments. The rubber seal (8) may be formed to suit a variety of contours or shapes of the lip or notch (9) or other means for opening or closing. The electrical circuit (56) may be made using either basic or advanced circuit components, circuit board(s), and electrical wiring.

Not all of the components listed or mentioned need to be included in order for the apparatus to be functional as a suitable storage solution. The apparatus could only use or include certain components, elements, or certain combinations of the many listed to provide adequate or suitable means such as: storage, organization, or heating. There are many variations. For example, the apparatus could still be used without any use of electricity, vacuum pumping, or latching means at all. The organizational and/or preparation means may or may not be needed and could be included when appropriate. The basic use of the enclosure (3) without any additions are practical for many applications.

Their are many basic uses and capabilities of the apparatus aside from any with the use of certain components, enhancements, or accessories. The very basic or mere elements of a lid (1), door (12), or other means for opening or closing, with or without a seal, and the enclosure (3) can be used for basic or simple storage means. The apparatus or enclosure (3) can be any type of container, receptacle, or pliable means and not limited to any specific type. Any additional components or accessories such as: a vacuum pump (17), latching means (20), heating element (66), or any of the mentioned components either in single, in part, or as a collection or in combination may or may not be included. It depends on the application in which it is being used. Any additional components added to the basic apparatus will be respective to the particular application in which it is being used. In reference to FIG. 19 for example, the basic components of means for opening or closing, with or without a seal, and an enclosure (3) can be combined with an external manual vacuum pump (25) which may be used to keep items for storage only. A different example would be the basic components combined with a heating element (66) and an automatic vacuum pump (17) which could be used for any of the following: marinating, warming, or cooking food. There are many variations and possibilities and not limited to any particular setup or version.

The apparatus could also come in a variety of shapes and sizes, and it could be made out of a wide variety of different materials. There are many possibilities. The apparatus or any of it's components may also be recyclable. The components could also be connected or associated differently as well. For example, certain circuit (56) components could be connected to each other in a variety of ways in order to carry out functions or tasks or the vacuum pump (17) or circuit (56) could be attached to the lid (1) of the enclosure (3) versus being attached within the enclosure (3) or within the housing or base (14). There are no limitations and any configurations or orientations are possible.

Optionally, In addition to the basic uses of the apparatus and components, it may also be equip with a variety of features, characteristics, or properties which may assist, compliment, or streamline its use. In any given version or variation, the core elements of the apparatus can make use of or apply any of these features, characteristics, or properties at any time. The way in which the apparatus is applied may greatly vary. There are many possibilities.

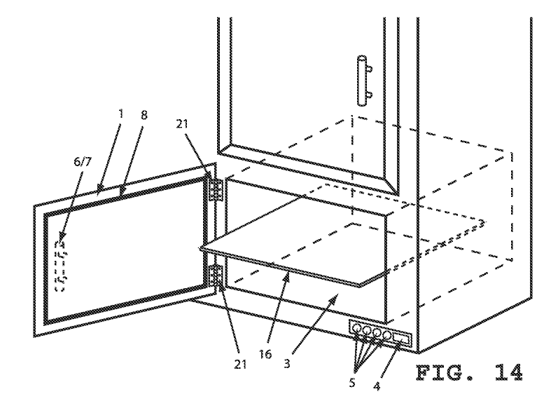

In reference to FIG. 14; The apparatus may be built-in to the kitchen or other environment. This will enable the complete setup to be installed directly into cabinet arrangements as well as other possibilities. It could also reside or be placed within other appliances or apparatuses such as a refrigerator or freezer. This will keep items permanently organized and will streamline the environment.

1. An apparatus which consists of:
a. An enclosure;
wherein provides means for opening or closing of the enclosure;
b. A seal to keep the enclosure sealed.

2. The apparatus of claim 1, whereas any of the following applies:
a. means for opening or closing an enclosure is a lid, door, or sliding door;
b. means for opening or closing the enclosure are able to be opened or closed with or by any of the following:
i. pushing the means;
ii. pulling the means;
iii. sliding the means;
iv. dropping the means;
v. setting the means down;
vi. screwing or unscrewing the means;
c. means for opening or closing the enclosure are able to achieve a seal with or by any of the following:
i. pushing the means;
ii. pulling the means;
iii. sliding the means;
iv. dropping the means;
v. setting the means down;
vi. screwing or unscrewing the means;
d. the means for opening or closing of an enclosure are assisted;
e. the enclosure is pliable or flexible;
f. the seal is air-tight or atmosphere-tight;
g. the seal is able to contain negative atmospheric pressure;
h. the seal is able to prevent moisture from entering or exiting the enclosure;
i. provides specific support for certain specific items kept within;
j. provides specific contoured support for certain specific items kept within;
k. the seal is any of the following:
i. made of rubber;
ii. rubber-like;
iii. pliable;
iv. flexible;
v. has an elastic property;
vi. made from any material;
l. the apparatus is able to eliminate or prevent conduction from impacting the environment or contents within the enclosure.

3. The apparatus of claim 1, whereas consists of manual or automatic vacuum pump means;
wherein vacuum pump means is able to create vacuum or partial vacuum, negative atmospheric pressure, or suction.

4. The apparatus of claim 3, whereas any of the following applies:
a. the means are able to create negative atmospheric pressure or suction to any amount, degree, or measurement;
b. the means for creating negative atmospheric pressure or suction is a vacuum pump powered by any power source;
c. the means for creating negative atmospheric pressure or suction is a vacuum pump powered by a power cord;
d. the means for creating negative atmospheric pressure or suction is an automated vacuum pump;
e. the means are activated, initiated, or engaged upon closure of the apparatus;
f. the means are able to be used with a pliable or flexible enclosure;
g. the means are able to create negative atmospheric pressure or suction within a pliable or flexible enclosure;
h. the means use a timer to control or regulate the duration or interval in which a vacuum pump is turned on or stays activated;
i. the means are adjustable by or via user interaction;
j. provides means to adjust pressure by or via user interaction;
k. the performance of the means is adjustable by or via user interaction;
l. the means are able to be connected or disconnected to or from the apparatus;
m. the means are able to be externally connected or disconnected to or from the apparatus via valve means;
n. provides suction means that are able to pickup particles of matter;
o. the means are able to be used to clean the apparatus;
p. communicates directly with the enclosure;
q. the means are able to be operated with any of the following:
i. manual dexterity;
ii. precision;
iii. human exercise;
iv. human exertion;
v. human strength.
v. the means communicate merely with a storage area.

5. The apparatus of claim 3, whereas negative atmospheric pressure or suction is created by one or more of the following:
a. a suction creating mechanism, device, or pump;
b. an electric pump;
c. a handheld pump;
d. a hand operated, actuated, exercised, or engaged pump;
e. an external, externally connected, or an externally used pump.

6. The apparatus of claim 1, whereas comprises one or more of the following:
a. internal means to connect or provide air passage to one or more of the following:
i. the enclosure;
ii. the seal;
iii. the means for opening or closing;
b. internal means for allowing the movement of air to or from the vacuum pump means;
c. means for removing unwanted elements present with or in air or means for cleaning air;
d. means for releasing pressure within the enclosure;
e. external valve means for external connection of a vacuum pump or suction means;
f. electrical means to provide power to the apparatus;
wherein electrical means is any type or from any source of power;
g. electrical circuit means;
h. timer means;
i. means to display or indicate things;
j. means for electrical control;
k. means for automation;
l. means for interaction between a user and the apparatus;
m. actuation means;
n. button means;
o. one touch button means or button means that are able to carry out one or more functions by engaging it one time;
p. lever means;
q. means for sensing or detecting the environment within the enclosure;
r. vacuum or pressure switch means;
s. means to further the security of a seal;
t. means for latching;
u. clasp means;
v. tubing;
w. handle means or means for gripping;
x. means for the enclosure to be any of the following:
i. coordinated;
ii. enhanced;
iii. sophisticated;
iv. organized;
v. customized;
vi. diversified;
y. means for organizing an enclosure;
z. means for customizing an enclosure;
aa. notch or indentation means for use with means for organizing or customizing;
bb. means to prepare items with any of the following:
i. one or more cutting board(s);
ii. means for creating heat;
iii. a heat chamber;
iv. a heat creating device or appliance;
cc. housing means or means to provide a frame or base for the apparatus;
dd. storage compartment means.

7. The apparatus of claim 3, whereas the manual vacuum pump means comprises:
a. an actuator, which is exercised in order to achieve a vacuum, partial vacuum, or suction;
b. two bodies, one of which is smaller, which is able to be inserted into or resides within a larger hollow body; both bodies of which have a gasket, seal, member, or rubber ring connected between them which forms a suction or negative atmospheric pressure creating mechanism or device by the movement between the gasket, seal, member, or rubber ring and one or more of the bodies which is able to be exercised by an actuator;
c. a valve or port to provide a way for air intake;
d. a valve or port to provide a way for air flow or a way for air to exit, so that the pump can continue to be exercised with lessoned resistance caused by the air;

8. The apparatus of claim 6, whereas means for organizing an enclosure are any of the following:
a. one or more rack(s);
b. one or more receptacle(s);
c. one or more tray(s);
d. one or more dish(es);
e. one or more removable enclosure(s);
f. one or more separator(s) used to separate or divide storage areas.

9. The apparatus of claim 1, whereas is operated, controlled or automated, or applies functions with electrical means that are one or more of the following:
a. raw;
b. direct;
c. simple;
d. basic;
e. conditioned;
f. from integrated circuit means;
g. processed;
h. from a microprocessor;
i. microprocessed or micro-processed;
j. from alternating current (AC);
k. from direct current (DC);
l. feedback;
m. from memory;
n. completely or entirely predetermined;
o. hard-wired;
p. timed.

10. The electrical circuit means of claim 6, whereas comprises means to initiate, activate, or engage the vacuum pump with one or more of the following:
a. a group of electrical components comprising:
i. pressure sensor means;
ii. raw electric controller means;
wherein the pressure sensor means is connected to or communicates with the raw electric controller means which is connected to or communicates with the vacuum pump in order to initiate, activate, or engage it.
b. pressure sensor means;
wherein the pressure sensor means is connected to or communicates with the vacuum pump in order to initiate, activate, or engage it.
c. a group of electrical components comprising:
i. electric controller means or raw electric controller means;
ii. pressure sensor means;
wherein the electric controller means or raw electric controller means is connected to or communicates with the pressure sensor means which is connected to or communicates with the vacuum pump in order to initiate, activate, or engage it.
d. raw electric controller means;
wherein the raw electric controller means is connected to or communicates with the vacuum pump in order to initiate, activate, or engage it.
e. electric controller means;
wherein the electric controller means is connected to or communicates with the vacuum pump in order to initiate, activate, or engage it.
f. a group of electrical components comprising:
i. electric activation means;
ii. vacuum or pressure switch means;
wherein the electric activation means is connected to or communicates with the vacuum or pressure switch means which is connected to or communicates with the vacuum pump in order to engage it.

11. The electrical circuit of claim 10, whereas one or more of the following applies:
a. any of the elements or groups are initiated, activated, engaged by one or more of the following:
i. electrical switch means;
ii. button means;
iii. lever means;
iv. electrical control means;
v. electrical activation means;
b. the raw electric controller means is one or more of the following:
i. raw intermediary means;
ii. raw timer means;
iii. raw processing means;
c. the electric controller means is one or more of the following:
i. intermediary means;
ii. timer means;
iii. microprocessor or processing means;
d. the electric activation means is one or more of the following:
i. electrical switch means;
ii. button means;
iii. lever means;
iv. electrical control means;
e. the vacuum or pressure switch means is connected to or communicates with the vacuum pump to activate, control, or terminate it's use.

12. The apparatus of claim 1, whereas an electrical circuit is able to do one or more of the following:
a. communicate, initiate, activate, or engage one or more electrical component(s) entirely with the use of preset, preprocessed, predetermined, pre-defined, or raw electric signals or circuitry;
b. carry out or complete one or more certain or specific operation(s) with the use of preset, preprocessed, predetermined, pre-defined, or raw electric signals or circuitry.

13. The apparatus of claim 12, whereas any of the following applies:
a. one or more component(s) are responsible for altering the pressure within the enclosure;
b. one or more certain or specific operation(s) is altering the pressure within the enclosure.

14. The apparatus of claim 1, whereas an electrical circuit is able to carry out or complete one or more certain or specific operation(s) with one or more component(s) that communicate with one or more component(s) that are aside from any component(s) in which had previously communicated.

15. The apparatus of claim 14, whereas one or more certain or specific operation(s) is altering the pressure within the enclosure.

16. The apparatus of claim 1, whereas pressure sensor or pressure detection means are initiated, activated, or engaged when negative atmospheric pressure has been created within the enclosure.

17. The apparatus of claim 1, whereas any of the following applies:
a. the electrical means are able to be supplied for other purposes;
b. the means to provide power are any of the following:
i. removable;
ii. detachable;
iii. retractable;
c. the electrical circuit means provide any of the following:
i. electrical or circuit component(s);
ii. component(s) that communicate directly with one another;
iii. component(s) that are able to provide user interaction;
iv. means to process electrical current or signals;
v. a microprocessor;
vi. memory;
vii. means to store data or user input;
d. the electrical control means provide means for electrical interaction between a user and the apparatus.

18. The apparatus of claim 6, whereas any of the following applies:
a. means for sensing or detecting the environment within the enclosure are any of the following:
i. pressure sensor or pressure detection means;
ii. spoilage sensor or spoilage detection means;
b. automation is achieved with or by the use of any of the following electrical means:
i. timer means;
ii. processing means;
iii. pressure sensor or pressure detection means;
iv. means for user interaction;
v. hard-wired or built-in function(s);
vi. means for user interaction via one touch component(s);
vii. means for user interaction via component(s) that are merely engaged a single time to complete an operation(s);
c. means for latching provide any of the following:
i. actuator means;
ii. handle means;
iii. hook means;
iv. pin means;
v. spring means;
vi. lever means;
d. the means for latching are able to pop the apparatus open;
e. tubing is used externally and is able to provide suction means.

19. The apparatus of claim 6, whereas any of the following applies:
a. a cutting board is retractable;
b. means for creating heat is or is produced by any of the following:
i. a toaster;
ii. a toaster oven;
iii. a magnetron;
iv. a heat producing pump;
v. a heating element;
c. heating means are electrically controlled.

20. The apparatus of claim 6, whereas any of the following applies to means for organizing an enclosure:
a. means are removable;
b. a separator is able to be used as a utensil or tool;
c. a separator is tapered or sharp;
d. a separator is able to function as a cutting board;
e. a separator is able to fit into another element or enclosure;
f. an element is able to fit into another element or enclosure with the use of grooves, slots, or special arrangements to support, hold, or keep the element stationary, sturdy, or in place;
g. an element is able to slide or fit into another element or enclosure with ease;
h. any of the elements provide specific support for certain specific items kept within;
i. any of the elements provide specific contoured support for certain specific items kept within;
j. any of the elements are of any size or shape;
k. any of the elements provide means for hanging or support;
l. when more than one same or similar elements are present they are stackable;
m. when more than one different or separate elements are present they are any of the following:
i. stackable;
ii. interchangeable;
n. when more than one of any of the following similar, different, or separate elements are present they are able to fit within one another:
i. a rack;
ii. a receptacle;
iii. a tray;
iv. a dish;
v. a removable enclosure;
o. any of the elements are able to eliminate or prevent conduction from impacting the environment or contents within an enclosure;
p. elements are able to be hung or supported.

21. The apparatus of claim 1, whereas any of the following applies:
a. the apparatus or any component or element of, is any shape or size;
b. the apparatus or any component or element of, is portable;
c. the apparatus or any component or element of, has any transparent quality or characteristic;
d. the apparatus is able to reside or be placed within other apparatuses or appliances;
e. the apparatus or any component or element of, is made of any type of material;
f. the apparatus or any component or element of, is any of the following:
i. dishwasher safe;
ii. microwavable;
iii. temperature resistant;
iv. recyclable.
